(19) United States
(12) Patent Application Publication
(10) Pub. No.: US 2021/0176021 A1
(43) Pub. Date: Jun. 10, 2021

(54) ADJUSTING METHOD FOR DATA TRANSMISSION

(71) Applicants: INVENTEC (PUDONG) TECHNOLOGY CORPORATION, Shanghai City (CN); INVENTEC CORPORATION, Taipei City (TW)

(72) Inventor: Zhi-Nan GUO, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 16/721,376

(22) Filed: Dec. 19, 2019

(30) Foreign Application Priority Data
Dec. 10, 2019 (CN) 201911260263.5

(51) Int. Cl. H04L 1/24; H04L 1/18; H04L 1/16

(52) U.S. Cl. CPC H04L 1/244; H04L 1/1642; H04L 1/188

(57) ABSTRACT

An adjusting method for data transmission, adapted to a first processor and a second processor for transmitting data through a network environment. The method comprises: performing a testing procedure to determine whether the network environment is a weak network environment by the first processor, attaching a first sequence header to a request data and outputting the request data having the first sequence header when the first processor determines the network environment is the weak network environment by the first processor, attaching the first sequence header and a second sequence header to a reply data corresponding to the request data when the second processor receives the request data by the second processor, and outputting the reply data having the first sequence header and the second sequence header to the first processor by the second processor.

### CROSS-REFERENCE TO RELATED APPLICATIONS

This non-provisional application claims priority under 35 U.S.C. § 119(a) on Patent Application No(s). 201911260263.5 filed in China on Dec. 10, 2019, the entire contents of which are hereby incorporated by reference.

### BACKGROUND

### 1. Technical Field

This disclosure relates to an adjusting method for data transmission, particularly to an adjusting method for data transmission when a network environment is a weak network environment.

### 2. Related Art

The technology of transmitting data through network environment is rapidly developed. However, when data is transmitted through the network environment, it often encounters situation with unstable network environment such as a weak network environment, which in turn affects the process of data transmission.

When the network environment is the weak network environment, the transmitted data is usually incomplete even though the network environment is still able to transmit partial data. Meaning, when the transmitted data is a concatenated packet consisting of a series of packets, not only the transmission of data may be interrupted due to the influence of the weak network environment, which may lead to packet loss and the subsequent packets not being transmitted. Besides, there is still no complete mechanism to ensure that the data transmitted through the network environment has higher importance when the network environment is the weak network environment.

### SUMMARY

According to one or more embodiment of this disclosure, an adjusting method for data transmission, adapted to a first processor and a second processor for transmitting data through a network environment, comprising: by the first processor, performing a testing procedure to determine whether the network environment is a weak network environment; by the first processor, attaching a first sequence header to a request data and outputting the request data having the first sequence header when the first processor determines the network environment is the weak network environment; by the second processor, attaching the first sequence header and a second sequence header to a reply data corresponding to the request data when the second processor receives the request data; and by the second processor, outputting the reply data having the first sequence header and the second sequence header to the first processor.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a flow chart of an adjusting method for data transmission according to an embodiment of the present disclosure;

FIG. 2 is a flow chart of a testing procedure according to an embodiment of the present disclosure; and

FIG. 3 is a flow chart of an adjusting method for data transmission according to another embodiment of the present disclosure.

### DETAILED DESCRIPTION

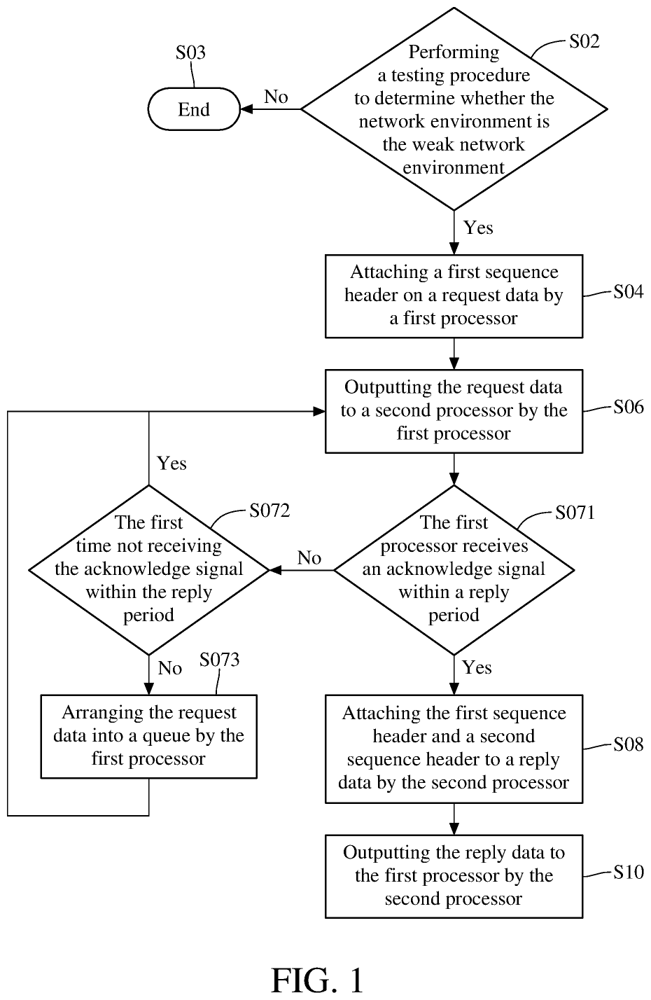

Please refer to FIG. 1. FIG. 1 is a flow chart of an adjusting method for data transmission according to an embodiment of the present disclosure. The adjusting method for data transmission of the present disclosure is preferably adapted to a first processor and a second processor for transmitting data through a network environment, wherein the first processor can be a user device, and the second processor can be a host server. The two processors can also be in the opposite configurations, or other hardware, the present disclosure is not limited thereto.

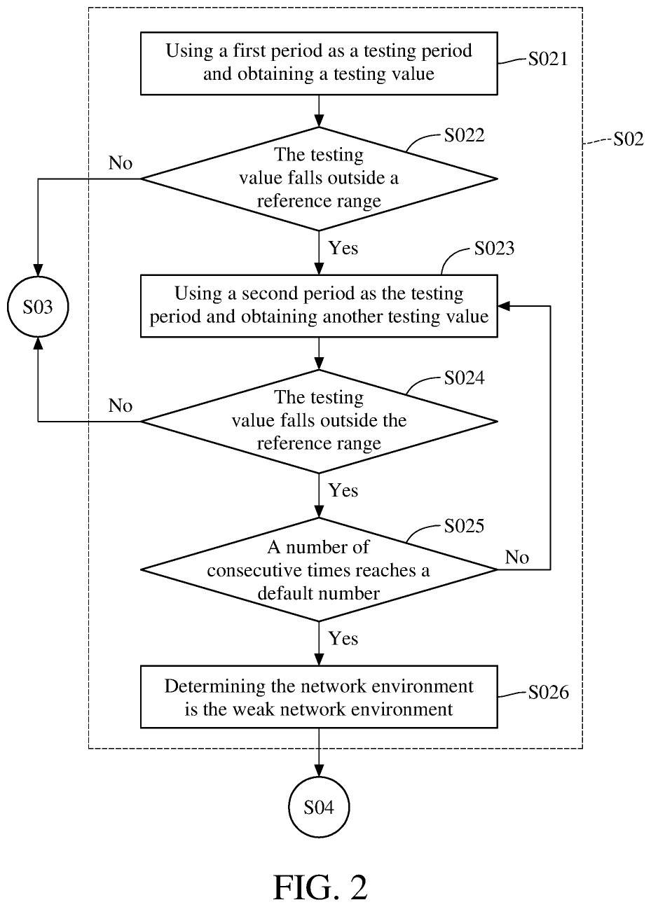

Please refer to step S02: performing a testing procedure to determine whether the network environment is the weak network environment. In detail, when the first processor is going to transmit a data to the second processor through the network environment, the first processor performs the testing procedure on the network environment to determine whether the network environment is the weak network environment. The weak network environment is, for example, a network environment in which the data transmission time exceeds a predetermined time, amount of the data transmitted is lower than a predetermined amount, or a signal strength of the network environment is lower than a predetermined strength, the present disclosure is not limited thereto. In other words, when the network environment is the weak network environment, the network environment's ability to transmit data is impaired, causing the interruption of data transmission, wherein the testing procedure will be described in more detail in the following embodiment of FIG. 2.

Please continue referring to FIG. 1. When the first processor determines the network environment is not the weak network environment in step S02, the first processor ends the method in step S03.

On the contrary, when the first processor determines the network environment is the weak network environment in step S02, the first processor subsequently attaches a first sequence header on a request data in step S04. In detail, the request data is, for example, a packet. When the first processor is going to output a concatenated packet consisting of a series packets (meaning the request data includes the concatenated packet), the first processor attaches the first sequence header on the first packet, and the first sequence header is preferably a serial location of the packet in the concatenated packet. Meaning, the first sequence header is a header in the series, and the header can be a number, an alphabet, or a combination of the number and alphabet, the present disclosure is not limited thereto. In addition, the first processor and the second processor that both learn the serial location of the first sequence header in the series are suitable for the adjusting method for data transmission of the present disclosure. Therefore, the content of the series described above is not necessarily to be a list of numbers from small to large, or a list of alphabets from “A” to “Z”. Aside from the first sequence header, the request data can also have a weighing value. Therefore, the first processor can determine the sequence of outputting the request data and another request data according to the weighing value of the request data and another weighing value of the said another request data. Accordingly, the first processor can output multiple request data sequentially based on the first sequence header, or categorize the multiple request data into a plurality of data groups based on the weighing values, and then output the request data in the current data group based on the first sequence header when outputting the data groups. The present disclosure is not limited thereto.

In addition, the request data can be contained in a command file, the command file further includes another request data, and a data size of the command file exceeds a default size. In detail, when the network environment is the weak network environment, and the default size is, for example, a maximum transmission size, the request data can be transmitted in the form of command file when the data size of the command file exceeds the default size, so as to avoid important data being left out during transmission.

After the first processor attaches the first sequence header at the request data in step S04, the first processor then outputs the request data to the second processor in step S06, wherein the request data outputted by the first processor in step S04 includes the first sequence header.

After the first processor outputs the request data in step S06, the first processor then determines whether the first processor receives an acknowledgement signal within a reply period in step S071, so that the first processor can determine whether the second processor has received the request data.

When the first processor does not receive the acknowledgement signal within the reply period, the first processor then determines whether it is the first time not receiving the acknowledgement signal within the reply period in step S072, and when the first processor determines it is the first time not receiving the acknowledgement signal within the reply period, the first processor outputs the request data to the second processor in step S06.

On the contrary, when the first processor determines it is not the first time not receiving the acknowledgement signal within the reply period in step S072, the first processor then arranges the request data to a queue in step S073. Therefore, the first processor can return to step S06 to output the request data to the second processor after a few operation cycles. Accordingly, the first processor can output other request data first, and then output the request data that is in the queue after finishing outputting other request data, to avoid other request data not being transmitted due to not receiving the acknowledge signal.

Please referring back to step S071. When the first processor receives the acknowledge signal within the reply period, the second processor then attach the first sequence header and a second sequence header to a reply data in step S08, wherein the content of the reply data is the request data having the first sequence header. Steps S071 to S073 described above are used for the first processor to determine whether data transmission between the first processor and the second processor is affected by the weak network environment and to resend the request data at a proper moment.

Please refer to step S06 and S08 together. In detail, the first processor outputs the request data to the second processor in step S06 to request the reply data from the second processor that corresponds to the request data. The request data outputted by the first processor includes the first sequence header, so that the second processor can learn whether the request data transmitted by the first processor is skipped based on the first sequence header, and further determine whether to request the skipped request data from the first processor.

After generating the reply data according to the request data, the second processor attaches the first sequence header and the second sequence header to the reply data in step S08, wherein the second sequence header is preferably the serial location of the reply data in the series of multiple reply data. The second processor then outputs the reply data having the first sequence header and the second sequence header to the first processor in step S10. Similar to the first sequence header, the first processor and the second processor that both learn the serial location of the second sequence header in the series are suitable for the adjusting method for data transmission of the present disclosure. Therefore, the content of the series is not necessarily to be a list of numbers from small to large, or a list of alphabets from “A” to “Z”. Similarly, after step S10, the second processor can also perform a similar resend mechanism of steps S071 to S073 described above, to decide whether to send the reply data again based on whether receiving the acknowledge signal sent by the first processor within the reply period. Accordingly, the first processor can determine whether the packets sent by itself or the reply data sent by the second processor is lost in the weak network environment based on the first sequence header and the second sequence header.

Please refer to FIG. 2. FIG. 2 is a flow chart of a testing procedure according to an embodiment of the present disclosure. The testing procedure disclosed in FIG. 2 is preferably used to determine whether the network environment is the weak network environment. The testing procedure can include testing the data transmission time, size of data transmission, or signal strength of the network environment. In detail, testing the data transmission time is testing whether the time of transmitting data through the network environment exceeds the predetermined time; testing the size of data transmission is testing whether the size of data transmitted through the network environment exceeds the predetermined size; and testing the signal strength of the network environment is testing whether the signal strength of the network environment exceeds the predetermined strength.

The first processor uses a first period as a testing period in step S021, and obtains a testing value under the condition of using the first period as the testing period. The first processor then determines whether the testing value falls outside a reference range in step S022. Take the above data transmission time as an example, the testing value is, for example, the actual time from the first processor outputting a testing data to the second processor, to the first processor receiving the testing data from the second processor. The reference range is, when the network environment is not the weak network environment, an ideal time from the first processor outputting the testing data to the second processor, to the first processor receiving the testing data from the second processor.

It is worth noting that, the reference can be obtained based on multiple testing values. In other words, when the network environment is not the weak network environment, the obtained testing value is the testing value when the network environment operates normally. Therefore, after obtaining the testing values that are obtained when the network environment is not the weak network environment, the reference range can be a range composed of the average of the testing values with an allowable error value. The reference range can also be a range composed of a confidence interval of a normal distribution derived from performing a normal distribution analysis on the testing values. The present disclosure is not limited thereto.

Therefore, when the first processor determines the testing value does not fall outside the reference range (meaning the testing value falls into the reference range) in step S022, meaning the described actual time does not exceed the ideal time, the first processor subsequently ends the method in step S03. On the contrary, when the first processor determines the testing value falls outside the reference range in step S022, meaning that the described actual time exceeds the ideal time, the network environment is subsequently considered may be the weak network environment.

Accordingly, the first processor then uses a second period as the testing period in step S023 and obtains the testing value when the testing period is the second period, wherein the second period is shorter than the first period.

The first processor determines whether the testing value falls outside the reference range in step S024, wherein the testing value and the reference range can be the actual time and ideal time described above. When the first processor determines the testing value does not fall outside the reference range (meaning the testing value falls within the reference range), ends the method in step S03.

On the contrary, under the circumstance of the second period being the testing period, when the first processor determines the testing value falls outside the reference range in step S024, the first processor then determines whether a number of consecutive times that the testing value falling outside the reference range reaches a default number in step S025. In other words, the first processor whether the testing value consecutively falls outside the reference range in step S025.

When the first processor determines the testing value falls outside the reference range in step S024 and determines the number of consecutive times that the testing value falling outside the reference range does not reach the default number in step S025, the first processor returns to step S023 to obtain the testing value using the second period as the testing period. On the contrary, when the first processor determines the testing value falls outside the reference range in step S024 and determines the number of consecutive times that the testing value falling outside the reference range reaches the default number in step S025, the first processor determines the network environment is the weak network environment in step S026. The first processor can continue to perform step S04 as shown in FIG. 1 to attach the first sequence header to the request data.

Meaning, the first processor determines whether the network environment is the weak network environment by determining whether the number of consecutive times that the testing value falls outside the reference range reaches the default number. In addition, when the network environment is the weak network environment, the first processor can perform the testing procedure repeatedly at a frequency to determine whether the network environment is still the weak network environment.

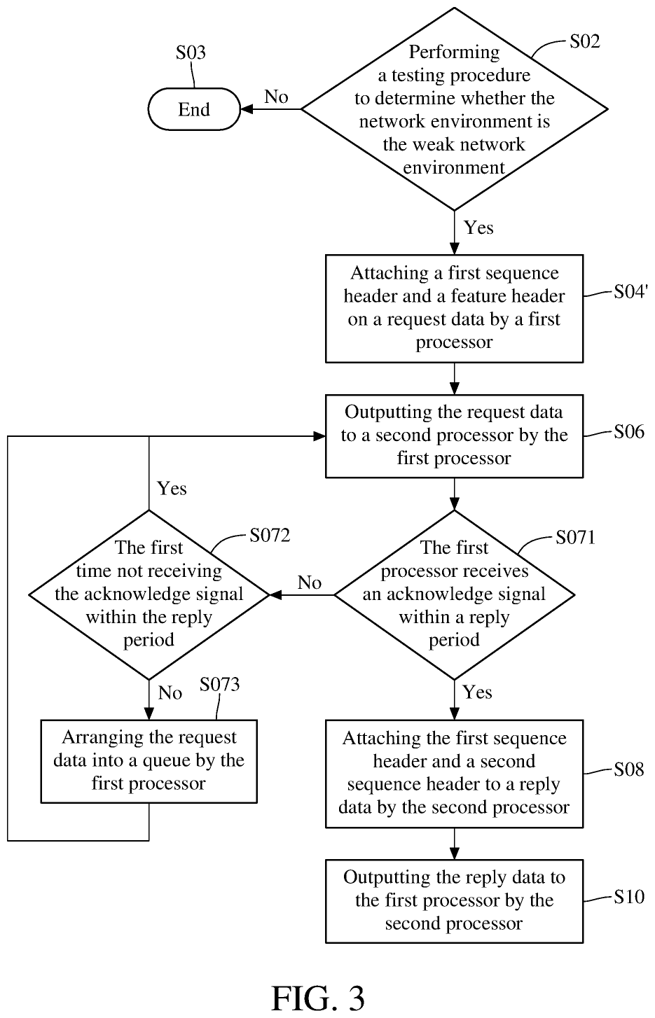

Please refer to FIG. 3. FIG. 3 is a flow chart of an adjusting method for data transmission according to another embodiment of the present disclosure. Steps S02 to S03 and steps S06 to S10 are preferably the same as the steps S02 to S03 and steps S06 to S10 disclosed in FIG. 1, which won't be further described. Step S02 disclosed in FIG. 3 is preferably implemented by steps S021 to S023 disclosed in FIG. 2. FIG. 3 is different from FIG. 1 in step S04′ disclosed in FIG. 3.

Please continue referring to FIG. 3. When the first processor determines the network environment is the weak network environment by performing the testing procedure, the first processor attaches the first sequence header and the feature header on the request data, wherein the first sequence header is preferably the same as the first sequence header described above, the present disclosure is not limited thereto.

In detail, the first processor can attach the first sequence header and the feature header to the request data, and the feature header can include the verification code of the request data, or include the data length of the concatenated packet of the request data. The verification code can be derived by performing a verification operation on the request data, wherein the verification operation is, for example, a hash function, and the verification code, for example, a hash value; and when the request data is a plurality of request data, the feature header can include the data length of the plurality of request data.

Therefore, when the first processor outputs the request data to the second processor in step S06, the second processor can determine whether the request data transmitted by the first processor is skipped, or the request data sent by the first processor is correct based on the first sequence header and the feature header. In turn, the second processor can determine whether to request the first processor to resend the skipped request data.

In view of the above description, according to one or more embodiments of the adjusting method for data transmission of the present disclosure, when the transmitted data is a concatenated packet consisting of a series packets and data transmission being interrupted when the network environment is the weak network environment, situations such as packet loss may be avoided. Furthermore, the situation of subsequent packets not being transmitted due to packet loss may also be avoided. In addition, according to one or more embodiments of this disclosure, it is also ensured that the transmitted data has higher importance when the network environment is the weak network environment.

The present disclosure has been disclosed above in the embodiments described above, however it is not intended to limit the present disclosure. It is within the scope of the present disclosure to be modified without deviating from the essence and scope of it. It is intended that the scope of the present disclosure is defined by the following claims and their equivalents.

What is claimed is:

1. An adjusting method for data transmission, adapted to a first processor and a second processor for transmitting data through a network environment, comprising:
performing a testing procedure by the first processor to determine whether the network environment is a weak network environment;
by the first processor, when the first processor determines the network environment is the weak network environment, attaching a first sequence header to a request data and outputting the request data having the first sequence header;
attaching the first sequence header and a second sequence header to a reply data corresponding to the request data by the second processor after the second processor receives the request data; and
outputting the reply data having the first sequence header and the second sequence header to the first processor by the second processor.

2. The adjusting method for data transmission according to claim 1, wherein when the first processor determines the network environment is the weak network environment, the method further comprises: attaching a feature header to the request data by the first processor.

3. The adjusting method for data transmission according to claim 2, wherein the request data is contained in a concatenated packet, the feature header comprises a data length of the concatenated packet.

4. The adjusting method for data transmission according to claim 2, wherein the feature header comprises a verification code derived from performing a verification operation on the request data.

5. The adjusting method for data transmission according to claim 1, wherein after outputting the request data having the first sequence header by the first processor, and before attaching the first sequence header and the second sequence header to the reply data corresponding to the request data by the second processor, the method further comprises:
determining whether the first processor receives an acknowledgement signal within a reply period by the first processor;
determining whether it is the first time not receiving the acknowledgement signal within the reply period when the first processor fails to receive the acknowledgement signal within the reply period by the first processor;
outputting the request data to the second processor by the first processor when the first processor determines it is the first time not receiving the acknowledgement signal within the reply period;
arranging the request data to a queue by the first processor when the first processor determines it is not the first time not receiving the acknowledgement signal within the reply period; and
outputting the request data to the second processor by the first processor.

6. The adjusting method for data transmission according to claim 1, wherein the request data has a weighing value, and outputting the request data having the first sequence header by the first processor comprises: by the first processor, determining the sequence of outputting the request data and another request data according to the weighing value of the request data and another weighing value of the another request data.

7. The adjusting method for data transmission according to claim 1, wherein the request data is contained in a command file, and the command file further comprises another request data, and a data size of the command file exceeds a default size.

8. The adjusting method for data transmission according to claim 1, wherein, after determining the network environment is the weak network environment, the method further comprises: performing the testing procedure repeatedly at a frequency by the first processor.

9. The adjusting method for data transmission according to claim 1, wherein the testing procedure comprises:
using a first period as a testing period, and obtaining a testing value under the condition of using the first period as the testing period;
determining whether the testing value falls outside a reference range;
using a second period as the testing period and obtaining the testing value under the condition of using the second period as the testing period when the testing value falls outside the reference range, wherein the second period is shorter than the first period;
determining whether the testing value falls outside the reference range;
determining whether a number of consecutive times that the testing value falling outside the reference range reaches a default number; and
determining the network environment is the weak network environment when the number of consecutive times reaches the default number.
